(19) United States
(12) Patent Application Publication
(10) Pub. No.: US 2005/0197859 A1
(43) Pub. Date: Sep. 8, 2005

(54) Portable electronic data storage and retreival system for group data

(76) Inventors: James Charles Wilson, Plano, TX (US); Bradley Lee, Plano, TX (US)

Correspondence Address: STRAUB & POKOTYLO, 620 TINTON AVENUE, BLDG. B, 2ND FLOOR, TINTON FALLS, NJ, 07724, US

(21) Appl. No.: 10/760,172

(22) Filed: Jan. 16, 2004

(51) Int. Cl. G06F 17/60

(52) U.S. Cl. 705/2; 707/9

(57) ABSTRACT

Methods and apparatus for providing and using a portable electronic data storage and information retrieval system for healthcare and/or other types of applications are described. Each portable storage device (PSD) (e.g., smart card) for a group, e.g., household, allows the storage and retrieval of household level information in addition to individual household member data/information. Data/information is stored corresponding to different applications. The PSD is accessed by a service provider's computer system. Access to the data/information is secured via authentication and/or various encryption techniques. Various service providers or types of service providers have access to different portions of the information stored on the portable storage device based upon pre-arranged agreements and/or service needs. Access is controlled through security information and/or security modules which are used to limit access. Service providers can update network based information databases and/or update the information on the PSD, e.g., to indicate a particular service or treatment.

### FIELD OF THE INVENTION

The present invention relates generally to the field of information storage and retrieval and, more particularly, to the field of portable electronic data storage and retrieval devices and systems suitable for storing information corresponding to multiple group members in a secure manner.

### BACKGROUND OF THE INVENTION

The management and communication of information corresponding to a group of individuals, e.g.; a household, is an issue which confronts many different services, e.g., health services, government benefits services, financial services such as credit services, etc. As more and more services and distributed systems rely on digital information corresponding to an individual or group of individuals, the need for ways to securely communicate and provide the required information without disclosing it to other members of a group, service providers who do not need the information, or other individuals, continues to grow in importance.

Healthcare service providers are an example of a type of service provider which, to provide a service, may need what is normally considered confidential information on an individual or group of individuals who share a common identity or purpose, e.g., members of a family which form a household. Presently, heath care-related data and information on individuals and households is stored, retrieved, updated and maintained in a decentralized manner. Health care records and information on an individual are generally dispersed among various doctors' offices, hospitals, clinics, treatment centers, testing lab facilities, pharmacies, health insurance agencies, military services, government agencies, schools, public programs, private programs, etc. In addition, some health care-related records are stored and maintained by the individual. There are a wide range of healthcare programs and options available both in the private and public sectors. These programs include government-initiated programs such as Medicaid, Medicare, Food Stamps, Head Start, Immunization Services, Childhood Lead Poisoning Prevention Program, the Special Supplemental Nutrition Program for Women, Infants and Children (WIC), Commodity Supplemental Food Program (CSFP), Farmers' Market Nutritional Program (FMNP), various commercial insurance-initiated programs, as well as a growing array of private and miscellaneous programs which are focused on collecting and accessing demographic, anthropometric, nutritional, and medical information regarding members of a household in order to provide for their healthcare needs. Individuals and/or households, e.g., a group of individuals living together or related in some other way by common purpose or identity, may use a plurality of these programs. Individuals and/or households may frequently switch among different healthcare programs and/or service providers due to any number of factors, e.g., employer decisions, a change to a new job, relocation, a change in income level, etc.

Presently, there is a limited ability of service providers to obtain, transport, and update and individuals' demographic, anthropometric, nutrition, and medical data, etc. This problem is even more acute if the service provider is considered an out-of-network provider. Healthcare programs, both government-sponsored and those in the private sector, often operate independently; and generally their data collection efforts are not coordinated. Generally, many of these health care records and information that may need to be interchanged among service providers are stored on paper. The health care records and information that are stored electronically, are generally stored on a localized computer or database, unique to each service provider and/or unique to each healthcare program, and the information is not readily exchangeable among different service providers and/or healthcare programs.

This current approach of decentralization leads to waste and inefficiencies. For example, when an individual goes to a new doctor or service provider or enters a new program, generally a new set of forms must be filled out, processed, and retained regarding information such as employer, income level, household aggregate information, insurance provider, family medical history, allergies, known conditions, etc. There is generally very little transfer or sharing of this information among service providers, even in many cases where the different service providers are participants in the same network or healthcare program. Referrals from one doctor to another, transfers of medical records, second opinions, prescriptions, and test results are generally faxed, mailed or hand carried from one facility to another. This transfer process is generally tedious, complicated, time consuming, and error prone. Referrals are commonly lost or misplaced. Medical records and/or test results may be lost during a transfer or the transfer process may take too long to be useful. In some cases, a doctor, e.g., an emergency room doctor may need to access critical medical information during off-hours or on a holiday when the service provider retaining the records is closed or inaccessible. In such cases a doctor may run redundant tests to obtain the necessary information or may be forced to make a critical decision based on insufficient information. Ambiguities in written prescriptions, e.g., illegibility, unclear dosage levels, etc. are common requiring a contact with the doctor for clarity.

Updating patient information using the present approach is a tedious and laborious process. The lack of patient information sharing and duplication in effort that occurs tends to detract from the quality of care and increase overall health care costs; these factors militate against optimal follow-up care. There is a chronic need in the healthcare industry to both update and access patient information acquired by and tracked by multiple service providers and/or multiple healthcare organizations/programs. The limited updating, accessing, and tracking activities that do exist today are generally uncoordinated, redundant, and inefficient. Additionally, healthcare data must be stored and safeguarded in such a manner as to ensure individual privacy, yet maintain convenience to the individual and access by the healthcare providers.

Today, many healthcare programs remain paper-based and require multiple data entries by the program participants and by each service provider to maintain record currency. Some projects use magnetic-stripe technology as a cardholder verifier, and then send that information to a host processor for computation. Both paper and magnetic-stripe technology tend to maintain information separately on each household member, requiring a head of household to keep documentation on household members with separate pieces of paper or separate magnetic-stripe cards. Due to the limitations imposed by those paper-based systems and magnetic-stripe cards currently in use, there is very little sharing of information among programs and/or service providers, even when authorized and encouraged by the participants.

Most card-based initiatives in the past have been limited to the issuance of a magnetic-stripe card to each participant and using that card as an identifier for access to host-based systems. This card as an identifier approach has occurred with Medicaid and Food Stamps beginning in the 1990s and continues to be used through the current time.

Based upon the above discussions, there is a need for new methods and apparatus for storing and retrieving health care data as well as other types of confidential and non-confidential data used to provide services to individuals or groups of individuals. Methods and apparatus that provide for the storage and retrieval of individual health care information, household (group) health care information, and aggregated health care information for a household (group) of individuals on a single personal storage device would be beneficial assuming security/access issues can be satisfied. New methods and apparatus for health care information storage and retrieval that provide means to verify the cardholder, provide easy portability, provide security of the information, provide different levels of access to the different types of information, e.g., based on the type of service provider, and/or use commonality in data storage structures would be beneficial and could increase efficiency and/or increase the quality of the health care services provided.

In view of the above discussion, it should be appreciated that there remains a need for new methods and apparatus for health care information storage and retrieval that can be used to reduce and/or eliminate redundant systems, duplicate services, and/or duplicate data collection and thereby reduce overall costs and the amount of time dedicated to information transfer, retrieval and updating operations. Improvements in regard to data collection, transfer, distribution, and updating will allow service providers to direct a greater percentage of limited resources to actual productive activities, e.g., medical services related to treatment, in contrast to administrative overhead/wasteful redundant procedures such as transferring and/or recreating existing medical records and patient treatment histories.

### BRIEF DESCRIPTION OF THE FIGURES

FIG. 1 illustrates an exemplary portable electronic data storage and retrieval system implemented in accordance with the present invention.

FIG. 2 illustrates a more detailed representation of the exemplary portable storage device, e.g., smart card shown in the system of FIG. 1, implemented in accordance with the present invention.

FIG. 3 illustrates an exemplary portable storage device and multiple service providers that may retrieve and/or store data/information on the portable storage device.

FIG. 4 illustrates at a high level the data/access control and interface layers present in some smart cards implemented in accordance with the invention.

FIG. 5, which comprises the combination of FIGS. 5A and 5B, illustrates the steps performed in accordance with an exemplary method which uses a portable data storage device, e.g., smart card, to store and distribute group, e.g., household, information, e.g., medical information, insurance information, financial information, etc. in accordance with the invention.

### SUMMARY OF THE INVENTION

This invention includes methods and apparatus for enabling a secure portable electronic data storage and retrieval system. An exemplary embodiment of the invention may be used for the data storage and retrieval of group, e.g., household, healthcare data/information. The information stored in a secure manner on the portable data storage device includes a set of data for each member of a group which stores data on the portable data storage device. An exemplary group may be a family or other set of individuals, e.g., individuals related by common identity or purpose. Such a group may form what is generally described as a household. Each data storage device includes a set of information corresponding to each individual group member which uses the portable data storage device. The portable data storage device includes a set of group level information which optionally includes information aggregated from the sets of individual member information stored on the card. The group level information may include information which describes or otherwise provides information about the group that is not included in the information found in the individual group member data sets.

Access is limited to stored information, e.g., the ability of entities to read and update information on the portable data storage device, through the use of encryption and/or an on-board processor and security routines which control the input/output of data from the storage device. Entities which attempt to access the portable data storage device, e.g., smart card, may be service providers or group members. Access to stored data can be, and in various embodiments is, restricted in the case of service providers to access relevant to the service being provided as a function of the identity of the individual group member to which the service is provided. For example, while the card may store medical information corresponding to multiple individuals, a medical service provider may be limited to accessing medical information corresponding to the particular individual to whom the medical service is being provided. Financial service providers may be denied access to medical service information even though the information is stored on the same card. Different group members may be provided different levels of access to stored information. A head of the group, e.g., a head of household may be given access to the household (group) level information in addition to his/her own personal information. Individuals are normally provided access to their own individual information, but they may be restricted from accessing/altering particular parts of their data sets. For example, some medical information may be restricted from an individual's access while the individual may be able to access doctor appointment information and see a list of the medical records stored in his/her personal data set.

Service providers can update their information off-card, e.g., network- or office-based records, automatically using information read from the card. In addition, information can be stored on the card to update the information stored thereon by a service provider. For example, a doctor or hospital can download scans or test results as well as patient treatment information onto the card to make it available for later retrieval, e.g., by an insurance provider or the patients personal physician. While service providers normally retrieve and update records corresponding to an individual to whom a service is provided, the service provider may update records corresponding to multiple members when any one of the group members uses the card to obtain a service. In this manner, an insurance provider and/or other service provider can update the records for the entire household, e.g., when one household member is provided a service.

The invention may be used to maintain a portable secure centralized household health care data/information record, update the records of healthcare providers, and/or allow the controlled access of selected health care data/information among various healthcare service providers. In one exemplary embodiment the system includes: a portable data storage device (e.g., a smart card) used to store health care data/information and security information; a reader/writer device to read from or write to the portable storage device which has the ability to authenticate an individual to the portable storage device; and a computer system to process data, interface to external systems, directly input health related data/information, and/or interchange health care data/information with the portable storage device.

The portable storage device, in accordance with the exemplary embodiment of the invention, includes healthcare data/information on one or more individuals, related or unrelated, who form a group. For purposes of explaining the invention, the term household will be used to refer to a group. A “household” may refer to any organization, group, or family who shares a common identity or has a common purpose. For example, a “household” could apply to a “household” of geriatric patients living in the same ward of a nursing home, a family of parents and their biological children with one or more adults and dependents, a Boy Scout troop, etc. The portable device may easily transport the stored data (e.g., immunization records) to a location where they are needed and can be retrieved (e.g., doctor's office, dispensary, clinic or school). The data resident on the portable storage device, in one exemplary embodiment, is protected by one or more of the following: (1) the inaccessibility of the portable data storage device which remains with the head of household or other designated household member, until it needs to be accessed, and (2) authentication of the head of household or an individual member of the household as part of the access/authorization process. With the use of authentication, access to the data on the portable storage device is restricted to a person associated with the card (e.g., the head of household or a service provider). Exemplary authentication methods may include using a pre-established Personal Identification Number (PIN), a biometric(s), or both.

The portable storage device may contain demographic, anthropometric (e.g., height, weight, age), medical, and nutritional assessment data of each household member such as, but not limited to, healthcare appointments and referrals, blood type, medical conditions, allergies, immunizations, developmental and nutritional appraisals, vision and hearing screenings, digitized EKGs, laboratory results, diagnoses and treatments, etc. The portable storage device can be presented at healthcare facilities, service providers, or other places where health data such as one's immunization record is occasionally validated (e.g., kindergartens, schools, nurseries, or assisted living homes, etc.).

Not only can an authorized service provider read the healthcare data on the portable storage device, but also new and updated information can be written by an authorized healthcare service provider to the storage device. The portable data storage device may contain data/information written over time by multiple authorized healthcare professionals. In accordance with the invention, different service providers and/or different types of service providers may be allowed access to different portions of the data stored on the portable storage device. Different service providers may have different application modules interacting with corresponding application modules in the portable storage device and/or reader/writer device. Authentication authorization and security modules may be used to restrict access to information and to encrypt information. The data written to the portable storage device may include time tag information and/or service provider identity information, e.g., the date of the information update and the name (or ID code number) of the healthcare provider who performed the update. In this way, an individual's healthcare information can be continuously and/or periodically updated and the data's currency can be maintained with an update audit trail. However, access to the information remains protected, and the portable storage device is safeguarded by the cardholder who keeps it in his or her possession. Optionally, the data resident on the portable storage device could be further protected by biometric identifiers with the biometric template being stored on the portable storage device as well.

Another way to view this invention is to consider it in terms of inputs and outputs. The invention uses one or more of the following sources of inputs and/or updates: (1) the household members and/or service providers who provide their demographic data and/or other data used for authentication and/or access control; (2) authorized healthcare service providers such as doctors, nurses, lab technicians, etc., who take body measurements, document key medical data such as blood type, allergies, diagnoses and treatments, etc.; and (3) authorized healthcare program administrators who update the portable storage device by recording such things as government benefits or insurance benefits, or healthcare appointments and referrals. These inputs and updates create and maintain portable repositories of data, e.g., data sets, such as health records of convenience on portable storage devices, which the participants may transport to a variety of other health care service providers and program managers. The collected data can be used to represent a consistent view of each participant in the household. The outputs of these stored participant data records maybe provided, for example, to one or more the following: (1) the household members themselves who may obtain a printout upon demand of a shot record or other needed documentation to meet an individual or household need; (2) healthcare providers such as doctors, nurses and lab technicians who may need to access key medical data/information stored on the portable data storage device; and (3) program administrators who may need to update their internal systems based on data/information that was collected by other participating program agencies and/or authorized healthcare providers.

The invention provides a portable, multi-application, information and services data recording and delivery platform that can track demographic, anthropometric, nutritional, and medical data/information for households (optionally included aggregated information) and individuals in a given household. The invention can be used to improve efficiencies in data collection, data access, and/or data exchanges for the participating programs and service providers. It does this by placing shared medical, health and program data on the participant's portable storage device and through the mobility of that device, the data is available to participating healthcare providers and program agencies once the head of household authenticates himself to the portable storage device via the reader/writer device. The invention provides a household-focused solution in which services delivery is restructured to take advantage of the efficiencies and other benefits of overlapping caseloads and service providers, creating a continuum of care and supporting integrative case management.

In accordance with the invention one or more of the following activities may occur:
1) Each participating household in a given healthcare program may be issued a portable storage device (e.g., a smart card, key fob, or other device implemented in accordance with the invention) including data specific to the household participant(s). This portable storage device could include shared demographic, anthropometric, nutritional, medical, and/or other health-related data for each household member; and it could enable access to services or benefits.
The portable storage device could be used to enable delivery of economic benefits from government or insurance programs by transporting secure authorization and prescription data to service providers, such as food retailers and pharmacies. The head of household, service provider or household member could update household information at an aggregate level, or update personal information themselves or a particular household members. Nutritional information could be maintained on the portable storage device for each household member. Medical readings, health data, diagnoses, and treatments stored on the portable storage device would be updated by authorized healthcare service providers, but would be protected from updating/access from other service providers and/or group members.
2) The participating household could maintain possession of the portable storage device and would enable authorized service providers to access its data by providing the service provider with a PIN or other code which is used as a group member identifier and/or security code, e.g., a code that is used to identify or generate an access or encryption key. One pragmatic way to do that is through an authentication procedure that protects access to the information and economic benefits on the portable storage device, thus enhancing privacy of that information; authentication can serve as an electronic signature that certifies head-of-household consent or the consent of an individual group member in allowing a health provider access to the patient information stored on the portable storage device.
3) Participating programs and/or service providers can share data through use of a common client record contained on the portable storage device, and would employ reader/writer devices that could read from or write to the portable storage device, e.g., subject to access restrictions. Thus, healthcare practitioners would take medical readings and store those readings on the portable storage device. That information would then be available to other healthcare practitioners or other authorized entities. For example, after a healthcare practitioner had updated the immunization records of children in a given household, school officials might access that information to confirm that the children met their immunization requirements. School officials may be restricted from obtaining access to other medical records and/or other information on the portable device, e.g., financial information.
4) The participating programs can transfer data via offline methods such as network data connections and/or the Internet. Such communications would normally be implemented using encryption or other security techniques such as the use of a private secure data network for communication purposes. The portable storage device can, and in various embodiments is, used as the trusted carrier of data among program agencies and among service providers which are not networked together in a secure fashion. Any provider of healthcare-related services could participate in this data sharing given that it is authorized by the card-issuing entity and/or individual group member using the portable data storage device assuming they have a personal computer or other device with an appropriate card interface. This could engender a virtual network across a broad array of health providers, including government agencies, private practices, commercial programs, and community health and social services programs even in the case where such systems are not physically networked together. In various environments, the portable storage device can link into the existing program's systems with minimal restructuring, re-engineering, and/or re-deployment of assets.
5) Participating programs/service providers can transfer data via online methods using various security measures such as data encryption. The portable storage device could become a storage medium for public key encryptions or other encryption means to support secure transmission of information via telecommunications means to a central data repository. Access to the central data repository may be limited to the participating network of authorized service providers and authorized program agencies. The information on the central data repository could be securely downloaded to authorized healthcare providers and authorized program agencies without the requirement for the portable storage device to be physically present. This can increase convenience for the network participants, and still retain security and privacy of the acquired data.

The methods and apparatus of the present invention can be used to increase the efficiency of both public and private sector programs by enabling better tracking of information, by reducing paperwork and streamlining processes. The invention creates an efficient information platform that, in some embodiments, provides program intelligence and improves program decision-making. Moreover, it significantly increases the convenience of participating households.

Numerous additional features, benefits and embodiments of the present invention will be discussed in the detailed description which follows.

### DETAILED DESCRIPTION

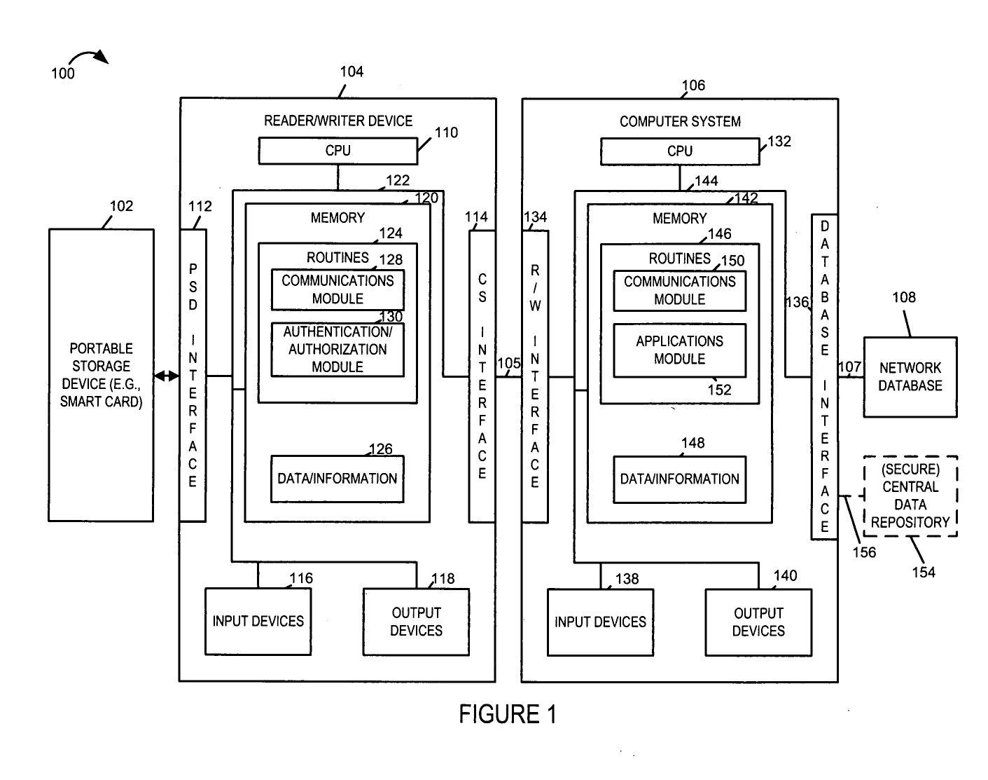

FIG. 1 illustrates an exemplary portable electronic medical data storage and retrieval system implemented in accordance with the present invention. Exemplary system 100 includes a portable storage device, e.g., a smart card, 102, a reader/writer device 104, a computer system 106, and a network database 108. Portable storage device, e.g., a smart card, 102 stores medical data for a household and individuals within the household. Reader/writer device 104 is coupled to computer system 106 via link 105; computer system 106 is coupled to a network database 108 via link 107. Reader/writer device 104, computer system 106, and network database 108 may be located at a health care service provider location or a location with a need to access medical related data/information, e.g., a doctor's office, a hospital, an ambulance, a medical insurance office, a school, etc. In addition, reader/writer device 104 and computer system 106 may be located in a home for use by a head of household and/or an individual member of the household. When portable storage device, e.g., smart card, 102 is interfaced to the reader/writer device 104, medical related information/data may be input and/or output from portable storage device 102 through reader/writer device 104 following authentication and authorization. System 100 supports the exchange of medical related data/information between the portable storage device 102 and service provider network database 108. In some embodiments, network database 108 is included as part of computer system 106.

Reader/writer device 104 includes a central processing unit (CPU) 110, a portable storage device (PSD) interface 112, a computer system (CS) interface 114, input devices 116, output devices 118, and a memory 120 coupled together via bus 122 over which the various elements may interchange data and information. Memory 120 includes routines 124 and data/information 126. Routines 124 include a communications module 128 and an authentication/authorization security module 130. CPU 110, e.g., a processor, executes the routines 124 and uses the data/information 126 in memory 120 to operate the reader/writer device 104 to: (a) authenticate that a portable storage device (e.g., smart card) 102 presented to a service provider belongs to the presenting individual, (b) authorize a service provider access to records stored on portable storage device 102, (c) control the transfer of information through reader/writer device 104, and (d) control the operation of the input and output devices 116, 118, respectively.

Portable storage device (PSD) interface 112 is an interface, used for coupling reader/writer (R/W) device 104 to portable storage device 102. In some embodiments, PSD interface 112 includes a connector, e.g., a socket type connector, coupled to interface circuitry, e.g., drivers, receivers, a power source, circuit protection elements, etc. In some embodiments, computer system interface 114 is a standard computer interface, e.g., a 232 port, a parallel port, a USB port, a firewall, a modem, etc. In other embodiments, computer system interface 114 is a unique interface, e.g., designed for use in system 100, which is coupled to a matching unique interface in computer system 106.

Input devices 116, e.g., keypads, keyboards, touch displays, biometric readers, etc., are used to enter data/information used in making decisions regarding authentication, authorization, information retrieval access, and information writing access. Information entered through input devices 116 may include a PIN entered by the cardholder (e.g., head of household) of the portable storage device (e.g., smart card) 102, biometric identity information obtained from the holder of the portable storage device (e.g., smart card) 102, and/or a service provider identity number or identity type entered by the service provider. In some embodiments, identity information, e.g., an identify number and/or biometrics pertaining to a patient, may be input through input devices 116. The cardholder and the person receiving the healthcare-related service need not be the same person, e.g., the cardholder may be a parent and the patient may be a dependent child. Output devices 118, e.g., displays, printers, speakers, etc., output instructional commands and/or messages to the user, e.g., insert card, enter PIN, access granted, access denied, individual positively identified, etc.

Communications module 128 controls the transfer of information, the structuring of messages over the communication interfaces 112, 114, implements the various communications protocols, used by reader/writer device 104. Authentication/authorization security module 130 uses data/information 126 to perform authentication of the holder (e.g., a head or household or an individual member in the household) of the portable storage device (e.g., smart card) 102, e.g., via checking of a PIN entered in input device 116 against an expected PIN accessed from portable storage device 102. Authentication/authorization security module 130 authorizes different levels of access to healthcare related data/information stored on PSD 102 for the head of household and for individual members of the household. In some embodiments, the head of household may be allowed access to the household level data/information and individual data/information for some or all of the members of the household, while an individual who is not the head of household may be restricted to data/information pertaining to himself/herself. Authentication/authorization security module 130 may verify the identity of the patient (e.g., a dependent child) against individual identity information stored on the portable storage device 102. Authentication/authorization security module 130 authorizes different service providers different levels of access to information in portable storage device 102 based upon service provider identify or category information, which may be entered via input device 116 or which may be transferred from service provider computer system 106. Authentication/authorization security module 130 performs encryption functions.

Data/information 124 includes information entered from input devices 116 such as PIN entries, data used for authentication comparisons and authorization access control, information used for encryption, messages to/from PSD 102, messages to/from computer system 106, and intermediate data being allowed to be routed through reader/writer device 104.

Computer system 106 includes a CPU 132, a reader/writer interface 134, a database interface 136, input devices 138, output devices 140, and a memory 142 coupled together via a bus 144 over which the various elements can interchange data and information. Memory 142 includes routines 146 and data/information 148. Routines 146 include a communications module 150 and an applications module 152. CPU 132, e.g., a processor, executes the routines 146 and uses the data/information 148 in memory 142 to operate the computer system 106. Operations performed by computer system 106 may include requesting access to portable storage device 102 for reading and/or writing information, receiving and processing data from PSD 102, outputting data to be written to PSD 102, storing and retrieving data from network database 108, and control the operation of the input and output devices 136, 140, respectively.

Reader/writer (R/W) interface 134 couples computer system 106 to reader/writer device 104. In some embodiments, R/W interface 134 is a standard computer interface, e.g., a 232 port, a parallel port, a USB port, a modem, etc. In other embodiments, R/W interface 134 is a unique interface, e.g., designed for use in system 100, which is coupled to a matching unique interface in reader/writer device 104. Database interface 136 is an interface allowing to network database 108 to be coupled to computer system 106 via link 107. In some embodiments, the database interface 136 is a local network interface. In other embodiments, e.g., where the network database 108 is located a remote site, the database interface may include a modem which may provide an Internet interface.

Input devices 138 may include, e.g., keypads, keyboards, touch displays, a computer mouse, etc. Input devices 138 may be used by the service provide to interface with the routines 146, to control other input devices 138 and to control output devices 140. Input devices 138 may include medical instrumentation devices with computer interfaces, e.g., a heart monitoring device, a blood pressure monitoring device, an imaging device, a blood testing device, etc.; these input devices 138 may be used to obtain additional medical related data and information on an individual. Output devices 140, e.g., displays, printers, strip recorders, speakers, etc. may output data and information which has been retrieved from PSD 102 and/or network database 108. Output devices 140 may output processing results, e.g., test results, tests images, etc. In addition, output devices 140 may output accounting, administrative, or management type healthcare related data/information, e.g., billing information, appointments, etc.

Communications module 150 controls the transfer of information, the structuring of messages over the communication interfaces 134, 136, implements the various communications protocols, and handles encryption used. Applications module 152 may include routines tailored to the service provider or type of service provider. For example, if computer system 106 is used in a doctor's office, applications routine may include office visit scheduling routines, billing routines, insurance routines, diagnostic routines, medical instrumentation control routines, referral routines, prescription routines, etc. However, if computer system 106 is used in an insurance claims office, applications module 152 may include a different set of routines, e.g., a claims processing routine and a medical procedure authorization routine. Different variations of the applications module 152, e.g., at different service providers may access different sets of household and/individual information stored on portable storage device 102.

Data/information 148 includes data/information entered from input devices 138 such as diagnosis, prescription, blood pressure, test results, etc. and data/information directed to output devices 140, e.g., data corresponding to the display of an MRI image. Data/information 148 includes messages to/from reader/writer device 104, messages to/from network database 108, and intermediate data being processed by computer system 106.

In some embodiments various elements of the system 100 may be merged. For example, the reader/writer device 104 may be merger with the computer system 106. In such an embodiment, one CPU may be used and the memory may be merged. In addition, in some embodiments, the network database 108 may be included as part of computer system 100. In some embodiments, the reader/writer device 104 may plug into a standard card slot, e.g., a PC card slot, in computer system 106.

In some embodiments, various components of the system 100 may be situated at different locations. For example, portable storage device 102 and the reader/writer device 104 may be situated in an emergency vehicle, e.g., an ambulance, while computer system 106 and network database 108 may be situated at a hospital. In such an embodiment, computer system interface 114 and read/writer interface 134 would include wireless communications capabilities, and medical data/information communicated over link 105 (e.g., a wireless link in this embodiment) would be encrypted for security.

Exemplary system 100 optionally includes a (secure) central data repository 154 coupled to computer system 106 via link 156. In some embodiments, encrypted heath data/information may be transmitted over link 156 to (secure) central data repository 154.

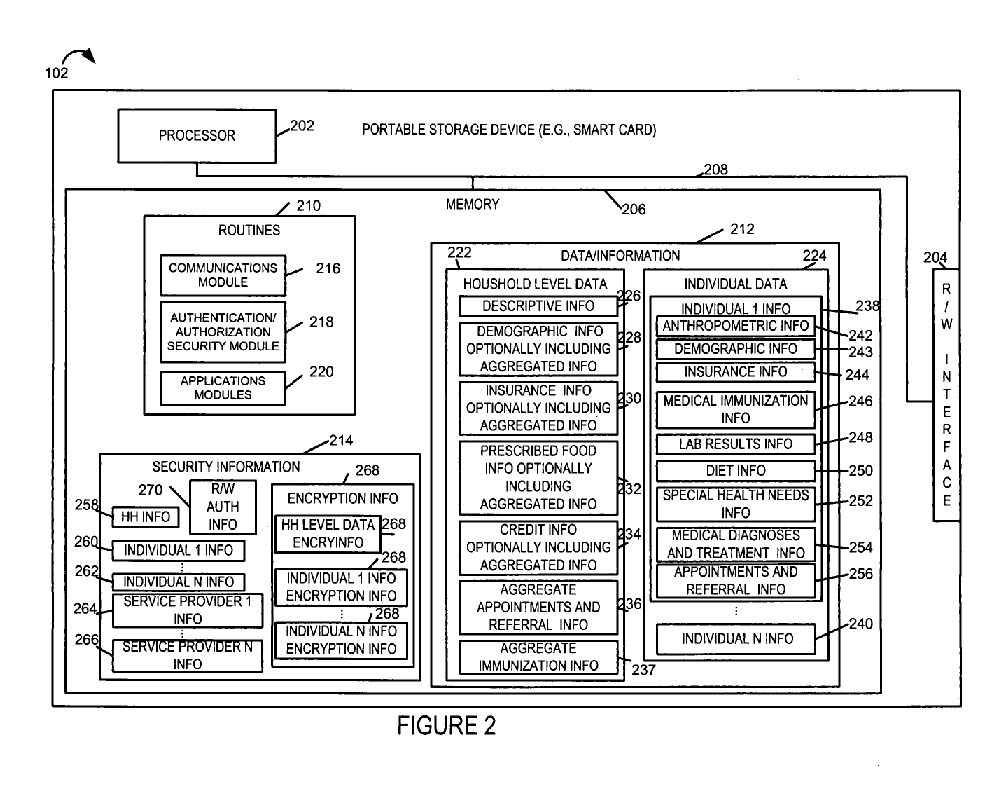

FIG. 2 illustrates a more detailed representation of the exemplary portable storage device (PSD), e.g., smart card, 102 shown in the system of FIG. 1, implemented in accordance with the present invention. Exemplary portable storage device 102 is easily transportable and small in size, e.g., it can easily fit into a shirt pocket, billfold, or purse. Portable storage device 102 can store vast amounts of data/information, e.g., megabytes and, in some cases, gigabytes, and is highly secure.

Exemplary portable storage device (e.g., smart card) 102 includes a processor 202, a Read/Write (R/W) interface 204, and a memory 206 coupled together via bus 208 over which the various elements may interchange data and information. Memory 206 includes routines, data/information 212, and security information 214.

Routines 210 include a communications module 216, an authentication/authorization security module 218, and applications modules 220. CPU 202, e.g., a processor, executes the routines 210 and uses the data/information 212 and security information 214 in memory 206 to operate the portable storage device 102 in accordance with the present invention.

Data/information 212 includes household level data 222 and individual data 224. Household level data 222 includes descriptive information 226, demographic information 228, insurance information 230, prescribed food information 232, credit information 234, aggregate appointments and referral information 236, aggregate immunization information 237. A household can be any organization, group or family which shares a common identity or a common purpose. Descriptive information 226 includes a household name, a designated individual designated as head of household, a physical address, telephone number, fax number, an e-mail address, and/or other contact information. Descriptive information 226 includes contact information for the PSD (e.g., smart card) issuer. Demographic information 228 includes demographic data at the household level such as the number of individuals in the household, aggregate income levels, the programs in which the household members participate, and other descriptive household data. Demographic information 228 may optionally include aggregated demographic information from the individuals in the household. Insurance information 230 includes information such as the insurance carrier(s), policy number(s), coverage provided, co-pays, conditions of payment, family deductible information, etc. Insurance information 230 may optionally include aggregated insurance information from the individuals in the household. Prescribed food information 232 includes prescribed food packages at an aggregate level for the individuals in the household. This could be food prescriptions designed by a nutritionist for a family or group of geriatric patients, or it could be a set of nutritional guidelines for a given household. Prescribed food information 232 optionally includes aggregated food information from individuals in-the household (e.g., an aggregate of individual diet information). Credit information 234 includes aggregated funds available to a head of household to buy prescription drugs and/or food. U.S. government sponsored programs such as WIC, CSFP, and/or FMNP prescribe specific food packages and provide economic reimbursement to food retailers. These programs are date specific and may cover single or multiple periods of time; such information could be included in credit information 234. Welfare programs, such as food stamps and Temporary Aid to Needy Families (TANF) could also have their funds deposited, e.g., credit information recorded in credit info 234. Credit information 234 may optionally include aggregated information from individuals in the household. Aggregate appointments and referral information 236 includes an aggregate of the appointments and referrals for the group of members in the household. Aggregate immunization information 237 includes an aggregate of individual medical immunization information 246 of the members of the group in the household.

Individual data 224 includes data for a plurality of users, e.g., individual members of a household. Exemplary individual 1 information 238 and exemplary individual N information 240 are shown in FIG. 2. Individual 1 information 238 includes anthropometric information 242, demographic information 243, insurance information 244, medical immunization information, lab results information 248, diet information 250, special health needs information 252, medical diagnostics and treatment information 254, and appointments and referral information 256.

Anthropometric information 242 includes data for the individual including height, weight, age, and other body measurements, e.g., neck size, waist line, bust, biceps, hips, etc. Demographic information 243 includes information on the individual such as income level, marital status, etc. Insurance information 244 includes the individual's insurance information, e.g., carrier, individual deductible information, etc. Medical immunization information 246 includes the type and date of immunizations for the individual. Preschool and school-age children must provide their immunization records to day care centers, kindergartens, nurseries, schools and Head Start centers in order to attend. Some travelers must provide proof on inoculations to enter certain countries. Having individual medical immunization data 246 on a portable storage device 102 would facilitate efficiency in these admission checking procedures. Lab results information 248 includes results from lab results, e.g., cholesterol levels, HIV analysis results, other blood analysis results, urine analysis results, skin culture analysis results, throat culture analysis results, etc. Diet information 250 includes prescribed diet or diet supplements tailored to the individual, e.g., a restriction on salt intake and/or a restriction on sugar intake. Diet information 250 could vary widely from individual to individual. Special health needs information 252 could include information on an individual's medical condition, e.g., diabetic condition, vision screening information, hearing screening information, allergy information, etc. Medical diagnoses and treatment information 254 can contain crucial data about an individual's medical condition, e.g., specific data for kidney dialysis, specific data for chemotherapy, specific data for an operation or procedure, etc. In many cases, the diagnostic center/diagnostic physician is different than the treatment center/treatment provider. Having individual medical diagnosis and treatment information 254 on portable storage device 102, enables a mobile and secure transfer of critical health data to an attending healthcare physician or other healthcare professional. Appointments and referral information 256 includes a listing of appointments at health care facilities, service providers, and/or agencies for the individual. Information 256 includes referral information, e.g., by a primary care physician for access to a specialist, e.g., a dermatologist, a cardiologist, etc.

Security information 214 includes head of household security information 258, individual 1 security information 260, individual N security information 262, service provider 1 security information 264, service provider N security information 266, and Read/Write (R/W) authorization information 270. Head of household security information 258 may include information used to verify that the head of household is indeed the person presenting the portable storage device 102 to a service provider at a reader/writer device 104 site. Head of household security information 258 may be used to verify that the head of household is requesting self access (e.g., at home) from PSD 102, as opposed to another individual member of the household requesting self-access. Heads of household presenting the portable storage device 102 to a service provider or requesting self-access may be provided special levels of access uniquely different from the access granted to individuals. It may be advantageous to restrict certain information to a head of household, e.g. household level credit information 234. In addition, a head of household may have a need to view or make available household level data including aggregated information from the individuals in a household. For example, a head of household may need to form a diet plan for the family and purchase the food and nutrient supplements for the family. A head of household may take care of minors or invalids and need access to aggregate information, e.g., to plan and schedule for appointments, obtain and dispense prescriptions, administer prescribed diets, etc. In some embodiments, heads of household may access household level data 222 and some or all of the individual data 224. In some embodiments, individuals, who are not the head of household, may access to their own individual data, but may not access household level data or other individual's data. In some embodiments, individuals, that are not the head of household, may only have self-access to portions of their own individual data. Individual 1 security information 260 includes security information, e.g., PINs, biometric information, etc., used to limit access to each set of individual 1 information 238, e.g., medical diagnostics and treatment information 254; individual 1 security information 260 may be used to verify that the person being attended to or processed corresponds to the set(s) of data/information being accessed from PSD 102. Individual N security information 266 includes security information used to limit access to each set of information included in individual N information 238; individual N security information 238 may be used to verify that the person being attended to or processed corresponds to the set(s) of data/information being accessed from PSD 102. Service provider 1 security information 264 may include information to positively identify service provider 1 or service provider type 1 and may be used to define which sets of information in data/information 224, service provider 1 or service provider type 1 may be allowed to access. Service provider N security information 266 may include information to positively identify service provider N or service provider type N and may be used to define which sets of information in data/information 212, service provider N or service provider type N may be allowed to access. Read/Write (R/W) authorization information 270 includes security information used to control which service provider or which type of service providers may be allowed to read from a specific set of data in data/information 212 and which service providers or type of service providers may be allowed to write to a specific set of data in healthcare related data/information 213.

Encryption information 268 includes household level encryption information 272, and a plurality of individual data encryption information, e.g., individual 1 encryption information 274, individual N encryption information. Household encryption level data 272 includes encryption information identifying a decryption key(s) to be used to decode the household level data. Distinct decryption keys may be used for each set of data, e.g., one key corresponding to descriptive information 226, another key corresponding to demographic information optionally including aggregated information 228, etc. Individual 1 encryption data 274 includes encryption information identifying a decryption key(s) to be used to decode the individual 1 information 238. Distinct decryption keys may be used for each set of data, e.g., one key corresponding to anthropometric information 242, another key corresponding to demographic information 243, etc. Individual N encryption data 276 includes encryption information identifying a decryption key(s) to be used to decode the individual N information 240. Distinct decryption keys may be used for each set of data within information N information 240.

Communications module 216 controls the transfer of data/information, the structuring of messages over the R/W interface 204, implements the various communications protocols. Authentication/Authorization security module 218 uses the security information 214 to authenticate a portable storage device 102 (card) holder, authenticate a service provider or type of service provider, authorize read and/or write access to information stored on PSD 102, and handle encryption of the data/information 212. In some embodiments, authentication/authorization security module 218 of PSD 102 works in conjunction with authentication/authorization module.130 of reader/writer device 130 to control the flow of data/information stored on PSD 102. Applications routines 222 may include routines for each category and/or for groups of categories of data storage. Applications routines 222 may be operate in conjunction with the applications module 152 in computer system 106. For example, a first application routine may correspond to appointments and referral information, and a second applications routine may correspond to insurance information optionally including aggregated information 230, while a third category may correspond to the combination of prescribed food information optionally including aggregate information 234 and credit information optionally including aggregated information 234.

In some embodiments, the processor 202 may be omitted from portable storage device 102, and the processor 110 of the reader/writer device 104 may be used execute the routines 210. In some embodiments, portable storage device does not include any routines 210, and routines controlling the portable storage device reside in the memory 120 of the reader/writer device 104. The data/information 212 stored in memory 206 may be stored as encrypted data/information in accordance with the invention.

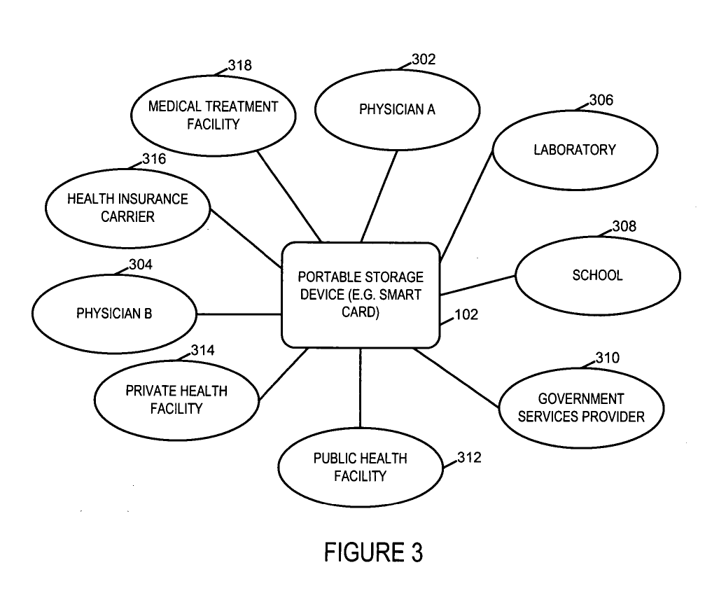

FIG. 3 depicts the inter-relationships of exemplary portable storage device 102 to a plurality of exemplary healthcare service providers. The portable storage device 102 platform serves as a trusted carrier among multiple programs and service providers, enabling critical data to transfer and be updated among the various entities. The data/information 212 remains portable and safeguarded by the authentication-protected portable storage methods of the present invention. In some embodiments the data/information 212 is additionally safeguarded by the use of encryption, e.g., data stored on PSD 102 in an encrypted format and/or data is transmitted in an encrypted format. The healthcare related data and information 212 or portions of data/information 212 is accessible by authorized service providers/users/agencies/users, etc. that are participating in the PSD system. Such participants may read and write via authorized application modules 152 in their computer systems 106 and using the correct security associations. Different application modules may allow different levels of access; the selection of application modules being tailored to the specific service provider or the type of service provider.

FIG. 3 underscores that a head of household or individual in the household can transport critical medical and healthcare data 213 via the data storage device 102 platform to supporting service providers, such as physicians (e.g., physician A 302, physician B 304, laboratories 306, schools 308, government service providers 310 (e.g., WIC, CSFP, etc.), public health facilities 312, private health facilities 314, health insurance carriers 316, and medical treatment facilities 318.

Once the portable electronic data storage and retrieval system 100 is deployed within a prescribed healthcare community (e.g., R/W devices 104 deployed and computer systems 106 loaded with the appropriate application modules 152, etc.), and the portable storage devices 102 are loaded with the appropriate application modules 220, participating households can use these devices at a large number of variegated venues. As FIG. 3 shows, data/information 212 can be carried via the portable storage device to a physician's office (e.g., physician A 302) and specific individual data records (e.g., medical diagnoses and treatment info 254) can be updated there. If the physician refers his patient to a medical treatment facility 318, then the patient's data can be securely transported via the portable storage device 102 by the head of household. This same portable storage device 102 can be used to update an array of programs, and get updated by them as well. For example, a child's immunization record (e.g., medical immunization info 246) updated at a public health facility 312 can be taken to the child's school 308 to provide proof of immunizations. Similarly, data updated by an insurer (e.g., insurance information 244) can be shared with a physician 302 to demonstrate proof of benefits. This invention can be used for the following exemplary applications:
1. Government agencies such as Medicaid, Medicare, Food Stamps, Head Start, Immunization Services, Childhood Lead Poisoning Prevention Program, the Special Supplemental Nutrition Program for Women, Infants and Children (WIC), Commodity Supplemental Food Program (CSFP), Farmers' Market Nutritional Program (FMNP), commercial insurance-initiated programs, as well as a growing array of private and miscellaneous programs which are focused on collecting and accessing demographic, anthropometric, nutritional, and medical information regarding members of a household in order to provide for their healthcare needs. These agencies would be key benefactors for using this invention to better share information on their overlapping cases.
2. Insurance companies in the healthcare field might use this invention in coordination with a network of physicians to capture key information about their patients and to update that information as itinerant patients travel to see physicians, dispensaries, treatment centers, hospitals, laboratories. The healthcare data on the portable storage device could travel with the patients and be updated by them.
3. The military could use this invention to maintain key information on soldiers and sailors for deployments globally and to continue to track that information after deployment.
4. Geriatric facilities could compile critical information on a number of patients, perhaps by ward, as they transport the patients in groups to a treatment center, pharmacy, or laboratory.
5. Schools, kindergartens and day care facilities could be outfitted with reader/writer devices to read and print out immunizations and other data regarding students or other children in their care.
6. Travelers could produce proof of medical condition upon entry into various countries.
7. Organizations such as the Boy Scouts could place physical fitness information and immunizations on a single card held by a scoutmaster when attending their adventure training or other special events in which each member of the troop (boys and adults) must prove their physical well-being before undertaking the training.

This invention can increase the efficiency of both public and private sector programs by enabling better tracking on information, reducing paperwork and streamlining processes. It creates an efficient information platform that provides program intelligence and improves program decision-making. Moreover, it can significantly increase the convenience with regard to obtaining services to participating households.

What has been described so far is a system where the data/information 212 that is placed on the portable storage device 102 remains on that device 102 until it is updated, or the data/information 212 is used to update a provider system, practice management system or program agency. Generally, if the portable storage device 102 is lost, then the data 212 on it cannot be recovered without re-visiting the network of healthcare providers and program agencies that are supporting the household.

In some embodiments, the updated data/information 212 on the portable storage device 102 is allowed to be transmitted to a central repository 154. Data resident on a lost or stolen portable storage device 102 could be recovered, and that would certainly increase participant convenience. It would enable authorized updates and transfers of individual and household information to occur without the physical presence of the portable storage device 102.

It is possible to mitigate the security issues and assuage some of the privacy concerns by encrypting the data that is. transmitted to the central data repository 154. Portable storage device 102 is capable of supporting extensive cryptographic functions by using authentication/authorization security module 218 and security information 214 including encryption information 268. Therefore, exemplary portable electronic data storage and retrieval system 100 supports the encrypted transfer of data across the Internet and/or other networks from a portable storage device 102 to a secured host, (e.g. secure central data repository 154).

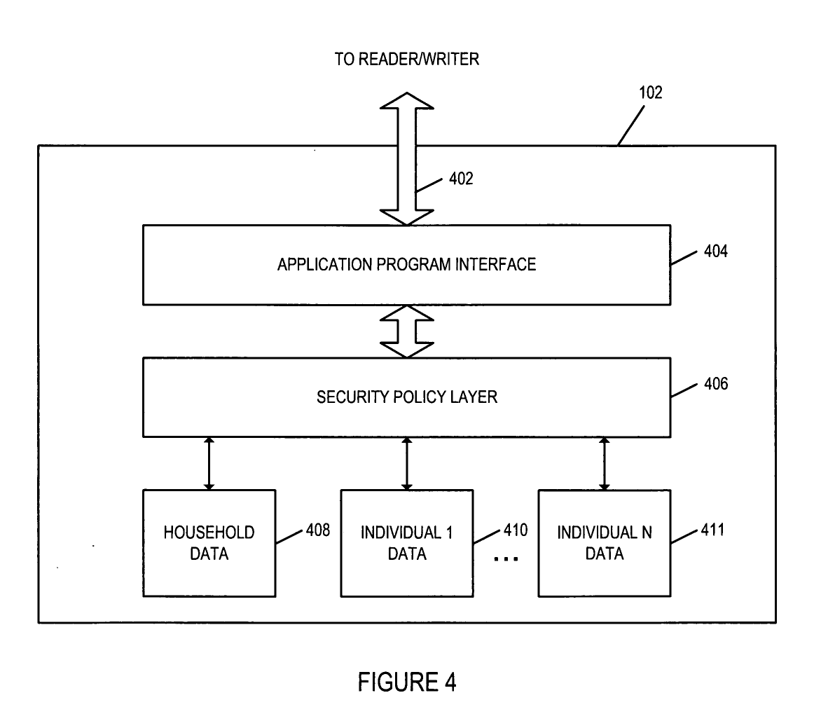

FIG. 4 illustrates at a high level the data/access control and interface layers present in some smart cards 102 implemented in accordance with the invention. As illustrated the smart card 102 interfaces with a reader/writer device via a data connection 402 and application program interface 404. Interface 404 servers to interact with requests/instructions from a reader writer and to convert them into a format which can be interpreted and used by the security policy application layer 406 which may be implemented as one or more security/authentication routines. Security policy layer 406 controls the level of access a individual group member and/or service provider has to the set of household level data 408 and individual group member data sets 410, 411 which each correspond to a different group, e.g., household, member.

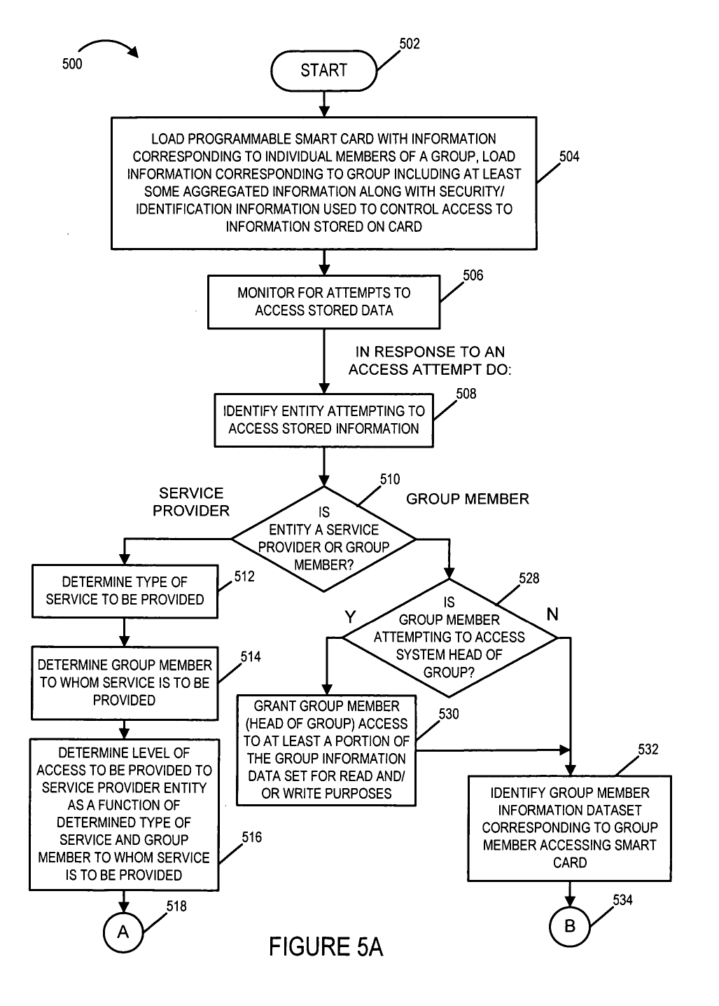

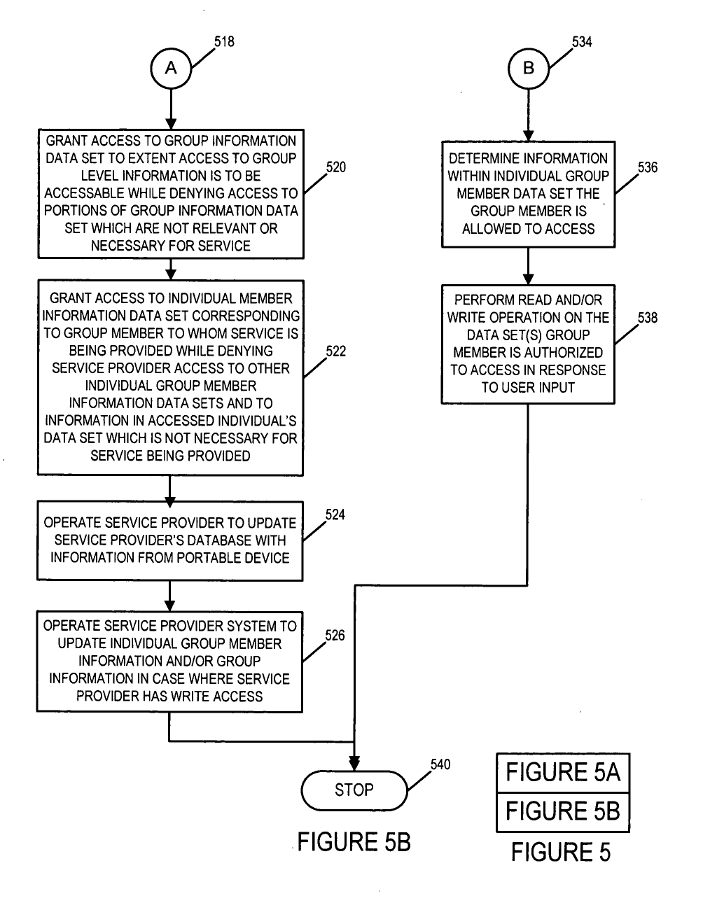

FIG. 5, which comprises the combination of FIGS. 5A and 5B, illustrates the steps performed in accordance with an exemplary method 500 which uses a portable data storage device, e.g., smart card, to store and distribute group, e.g., household, information, e.g., medical information, insurance information, financial information, etc. in accordance with the invention.

The method begins at start node 502 with processing beginning in step 504. In step 504 a smart card 102 is loaded with information corresponding to individual members of a group, e.g., household. The card 102 is loaded with group level information, i.e., information corresponding to the group that includes at least some aggregated information along with security and/or identification information used to control access to information stored on the smart card. The stored security/identification information may include user identification information, e.g., PINs and/or encryption information such as encryption keys and/or information used to determine the encryption key that is needed to decrypt the stored data. The stored data may include one data set for each of a plurality of household members. The individual member data set may include information relating to multiple services, e.g., medical services, financial services, etc. as discussed above.

After the card is initially loaded in step 504 with household level and individual household member information, operation proceeds to step 506 where monitoring for attempts to access stored data is performed. Step 506 may be performed by the processor or security application in embodiments where the data storage device is a smart card or by a reader/writer device where the portable data storage device is primarily a memory device, e.g., with the information stored thereon being protected through the use of encryption.

For each data access attempt detected in step 506, operation proceeds to step 508. In step 508 the entity attempting to access information stored on the portable data storage device, e.g., service provider or group member is identified. This may be done by requiring the entity to enter a PIN or other authentication information. In step 510 a determination is made to whether the entity seeking access is a service provider, e.g., health care service provider, or a group member such as the head of a household or other household member.

If in step 510 it is determined that a service provider is seeking access to the stored data, operation proceeds to step 512 where the type of service to be provided is determined. The type of service is used to determine the type of information to which the service provider is to be granted access. Then, in step 514 the group member to whom service is to be provided is determined. This information is used to determine which individual group member records and/or group level information the service provider should be allowed to access. In step 516, the level of access to be provided to the service provider is determined as a function of the type of service being provided and the group member to whom the service is to be provided. Operation proceeds from step 516 to step 520 via connecting node 518. In step 520 access is granted to the group information data set to the extent access to group level information is to be permitted while denying access to portions of the group information data set which are not relevant or necessary for the particular service being provided. Then, in step 522 access is granted to the individual member information data set or data sets corresponding to the group member or members to whom service is being provided while denying the service provider access to other individual group member information data sets, e.g., individual member information data sets who are not receiving the provided service, with information in the individual accessed data sets being limited to information which is necessary for providing the particular service being provided to the group member or members.

In step 524, the service provider updates a service provider information database, e.g., an office or network based database, with information obtained from the portable data storage device. Then in step 526, the service provider updates the individual group member information and/or group information data set on the portable data storage device, e.g., to reflect a medical treatment or diagnosis or other service which is provided, in the case where the service provider has write access. With the information on the portable data storage device having been updated to reflect the service provided by the particular entity accessing the portable data storage device, processing with regard to the particular service provider's card access is stopped at end node 540.

If in step 510 it was determined that the attempt to access the information stored on the portable data storage device corresponds to a group member, operation proceeds to step 528 where the status of the group member is determined. That is, in step 528, a determination is made, e.g., from authentication information supplied by the group member attempting to access stored data, if the group member is the head of the group, e.g., head of household, with corresponding group level information access rights. If the accessing group member is the head of the group operation proceeds to step 530, where the group member attempting to access the stored data is granted the right to access at least a portion of the group member information data set including, e.g., information aggregated from the individual data sets of multiple different individual group members. Operation proceeds from step 530 to step 532. In step 528 if it were determined that the group member attempting to access stored data was not the head of the group, operation would proceed directly from step 528 to step 532 skipping step 530.

In step 532, the individual group member information data set which corresponds to the group member seeking access to stored information is identified. Operation proceeds from step 532 to step 536 via connecting node 534. In step 536 a determination is made as to which information within the identified group member data set the group member is allowed to access. For example, the group member may be restricted from accessing some medical information while still being permitted to see a list of the information and/or his/her medical records which are stored on the portable data storage device. With the group member's permitted level of access being determined in terms of data sets which can be accessed and which information in the data sets can be accessed, operation proceeds to step 538. In step 538 the group member accessing the stored information is allowed to perform a read and/or write operation on the data sets which he/she is permitted to access subject to any access constraints. For example, a group member may be permitted to read some information but not modify it, e.g., medical history information. In other cases the group member may be permitted to read and write data such as information identify the group member's current home address and/or insurance provider(s). Change history information may be maintained and stored by the portable data storage device to indicate what changes are made to the stored data and when changes should be made.

Once the group member is done accessing the stored data, operation proceeds to step 540 where processing performed in regard to the group member's stored information access attempt stops.

Numerous variations on the above described embodiments are possible. For example, in the case of smart card embodiments, a card based processor and authentication/security routines may be used to control access to stored information as described in many of the steps shown in FIG. 5. In other cases, such authentication/security functions are performed in reader/writer devices used to access information stored on the portable data storage devices of the present invention. Thus, while shown in a smart card embodiment, it should be appreciated that the portable data storage device of the present invention could be implemented as a simple memory device with the data sets being stored in encrypted format and the reader/writer being responsible for data decryption after determining that an accessing entity has authority to access particular information and for encrypting information written to the data storage device to prevent unauthorized access of the data stored on the portable data storage device.

Various features of the present invention may be implemented in software. Such software is stored on a machine readable, e.g., the memory in the smart card or memory in the card reader/writer device. Accordingly, the present invention is directed to, among other things, a machine readable medium including computer executable instructions for controlling a device to perform one or more steps in accordance with the method of the present invention.

Numerous variations on the above described exemplary embodiments are possible while remaining within the scope of the invention.

1. A system which uses at least one portable device for storing and communicating information corresponding to a plurality of individuals who form a group, the system comprising:
a portable device including a memory, the memory including:
a plurality of data sets, said plurality of data sets including:
i) a plurality of individual member information data sets, each individual member data set corresponding to a different individual member in said group and including at least one of medical information, nutritional information, insurance information, financial information and appointment information specific to the individual group member;
ii) a group data set, the group data set including information corresponding to a plurality of members of said group, at least some information in said group data set being aggregated from multiple group member information data sets, said group data set including aggregated information corresponding to at least one of medical information, nutritional information, insurance information, financial information and appointment information; and
iii) access control information, said access control information including information being used to limit the amount of access different entities are provided to the content of said plurality of data sets, the amount of access provided by said access control information depending on at least one of the identity of an entity and a type of service to be provided by an entity.

2. The system of claim 1, wherein at least two different individual member information data sets both include insurance information and medical information, said group data set including at least some insurance information from each of said at least two different individual member information data sets.

3. The system of claim 1, wherein at least two different individual member information data sets both include nutritional information and financial information, said group data set including at least some nutritional information from each of said at least two different individual member information data sets.

4. The system of claim 1, wherein said access control information includes identification information, said identification information including information distinguishing different entities who may attempt to access the memory, said entities including at least one of a member of said group and a service provider.

5. The system of claim 4, wherein said access control information includes information used to identify different individual members of said group.

6. The system of claim 4, wherein said access control information includes information used to identify different service providers, said different service providers including at least two of a medical service provider, insurance service provider, credit service provider.

7. The system of claim 1,
wherein said individual group member data sets are stored in an encrypted format; different group member data sets being encrypted using different encryption information; and
wherein said access control information includes information used to decrypt encrypted individual group member-data sets, different encryption information being included for at least some different individual group member data sets.

8. The system of claim 7, wherein said access control information includes information sufficient to determine a decryption key that should be used to decrypt an individual group member data set, different decryption keys being used for different individual group member data sets.

9. The system of claim 8, wherein different encryption keys are used for information stored in an individual group member data set corresponding to different services.

10. The system of claim 1, further comprising:
an access control means for limiting access to different sets of data stored on said portable device to different entities, said different entities being providers of different types of services.

11. The system of claim 10, wherein said access control means limits the ability of different entities to read different portions of said stored data sets.

12. The system of claim 10, wherein said access control means limits the ability of different entities to update different portions of said stored data sets.

13. The system of claim 10, wherein said access control means limits a medical entity providing a medical service to reading and updating medical information stored in an individual group member data set corresponding to an individual group member to whom a medical service is being provided.

14. The system of claim 13, wherein said access control means limits the individual group member from obtaining access to the medical information stored in said individual group member data set.

15. The system of claim 10, wherein said access control means is included on said portable device, said access control means including:
a processor; and
at least one access control routine used to control the amount of access entities have to data sets stored in the memory of the portable device.

16. The system of claim 15, wherein said portable device is a smart card.

17. A method of communicating information corresponding to members of a group through the use of a portable device, the method comprising:
storing on the portable device including a memory a plurality of data sets, said plurality of data sets including:
i) a plurality of group member information data sets, each group member information data set corresponding to a different individual member of said group and including at least one of medical information, nutritional information, insurance information, financial information and appointment information specific to the individual group member; and
ii) a group data set, the group data set including information corresponding to a plurality of members of said group, at least some information in said group data set being aggregated from multiple group member information data sets;
providing different entities different levels of access to said plurality of data sets.

18. The method of claim 17, wherein said different entities include different service providers, and wherein said step of providing different entities different levels of access includes providing an entity a level of access to said plurality of data sets as a function of the type of service to be provided by the entity.

19. The method of claim 17, wherein the different service providers provide services to different members of said group, and wherein said step of providing different entities different levels of access further includes providing an entity a level of access to said plurality of data sets as a function of the identity of the group member to which said service is provided

20. The method of claim 19, wherein providing different entities different levels of access includes:
allowing an entity providing a first service to a first group member to access information stored in a first group member information data set corresponding to the first user, but preventing access by said entity to group member information data sets, stored on said portable data storage device, corresponding to other group members.

21. The method of claim 19, wherein providing different entities different levels of access includes:
restricting said entity providing the first service to the first group member to accessing information stored in the first group member information data set that corresponds to another service which is different said first service.

22. The method of claim 21, wherein said first service is a medical service and the information stored in the first group member information data set that corresponds to another service is financial information which corresponds to a financial service.

23. The method of claim 22, further comprising:
providing the entity providing the first service to at least a portion of said group data set which is relevant to the first service.

24. The method of claim 21, further comprising:
updating information corresponding to the first group member stored in a network database from information read from said portable storage device.

25. The method of claim 24, further comprising:
updating information corresponding to the first group member stored on said portable data storage device using information read from said network database.

26. The method of claim 25, wherein said network database is a database of medical insurance information; and
wherein the information used to update said medical insurance information database is patient treatment information read from said portable memory device.

27. The method of claim 21, further comprising:
updating information corresponding to a plurality of group members stored in a network database from information read from said portable storage device.

28. The method of claim 21, further comprising:
updating information corresponding to a plurality of group members stored in on said portable data storage device using information read from a network database.

29. The method of claim 28, wherein said portable data storage device includes in each group member data set, health care information corresponding to the group member to which the individual group member data set corresponds.

30. The method of claim 29, wherein said group is a household, each group member data set corresponding to a different member of said household.

31. The method of claim 17, wherein said entities are group members; and
wherein providing different entities different levels of access to said plurality of data sets includes providing a head of said group access to at least a portion of said group data set and access to at least a portion of the group member information data set which corresponds to said head of said group.

32. The method of claim 31, wherein said entities are group members; and
wherein providing different entities different levels of access to said plurality of data sets includes providing at least some members of said group access to their corresponding group member information data sets, but not to said group data set.

33. A portable data storage device for communicating information corresponding to a plurality of members of a group, comprising:
a memory, the memory including a plurality of data sets, said plurality of data sets including:
i) a plurality of individual member information data sets, each individual member data set corresponding to a different individual member in said group and including at least one of medical information, nutritional information, insurance information, financial information and appointment information specific to the individual group member;
ii) a group data set, the group data set including information corresponding to a plurality of members of said group, at least some information in said group data set being aggregated from multiple group member information data sets, said group data set including aggregated information corresponding to at least one of medical information, nutritional information, insurance information, financial information and appointment information; and
iii) access control information, said access control information including information used to limit the amount of access different entities are provided to the content of said plurality of data sets, the amount of access provided by said access control information depending on at least one of the identity of an entity and a type of service to be provided by an entity.

34. The portable data storage device of claim 33, further comprising:
a processor;
a security routine, in said memory, said security routine performing a user authentication operation using information provided by a group member,
said information being used to authenticate said group member and to indicate user authorization to provide at least some stored information.

35. The portable data storage device of claim 1, wherein said data storage device serves as a secure method of communicating medical information without the need to transfer said information over a communications network to a service provider, said portable data storage device including in said memory in one of said individual member information data sets:
medical insurance information for a group member;
medical history information for said group member; and
an X-Ray in digital form, said X-Ray corresponding to said group member.
